(19) United States
(12) Patent Application Publication
(10) Pub. No.: US 2016/0073621 A1
(43) Pub. Date: Mar. 17, 2016

(54) Enclosure for Killing Insects

(71) Applicant: Scott Nielson, Fruit Heights, UT (US)

(72) Inventor: Scott Nielson, Fruit Heights, UT (US)

(21) Appl. No.: 14/216,311

(22) Filed: Mar. 17, 2014

Related U.S. Application Data
(60) Provisional application No. 61/792,460, filed on Mar. 15, 2013.

(51) Int. Cl. A01M 1/00

(52) U.S. Cl. CPC A01M 1/00; A01M 2200/011

(57) ABSTRACT

A system configured to heat items to a temperature sufficient to kill bed bugs includes an enclosure and a hydronic heating system. The hydronic heating system is capable of heating the interior of the enclosure to at least approximately 110° F. The hydronic heating system includes a heater that heats a liquid. The liquid is used to transfer heat into the interior of the enclosure. In one embodiment, the hydronic heating system includes a hydronic radiant heating system and a hydronic forced air heating system. The enclosure can be used to kill bed bugs by positioning an item that includes bed bugs in the enclosure and heating the interior of the enclosure to a temperature and for a duration that is sufficient to kill the bed bugs.

### CROSS-REFERENCE TO RELATED PATENT APPLICATIONS

This claims the benefit of U.S. Provisional Pat. App. No. 61/792,460, titled “Enclosure for Killing Insects,” filed on 15 Mar. 2013, the entire contents of which are incorporated by reference into this document.

### BACKGROUND

Bed bugs are parasitic insects that feed on human blood. They have been recognized as human parasites for thousands of years. Bed bugs were a common problem in most of the world up through World War II. Around this time, they were virtually eradicated in the developed world with the wide scale use of pesticides such as DDT and Malathion.

In the late 1990's bed bugs began to re-emerge as a pest in the developed world including the United States. Their secretive behavior coupled with a lack of public awareness has enabled bed bugs to move efficiently from one dwelling to another and has facilitated their rapid dispersal throughout the developed world.

It is difficult to pin point the cause of the resurgence of bed bugs but there are a number of factors that have likely influenced the re-emergence of this difficult pest. Changes in pest management practices coupled with the development of resistance to modern day pesticides has contributed to the successful re-establishment of bed bug populations, particularly in the United States.

For example, hotel rooms used to be treated on a regular basis with residual pesticides so that bed bugs introduced during travel were likely to contact the pesticide as they left the luggage and traveled to the bed. During the mid 1990's there was a dramatic shift in pest management practices. Hotels, motels, and apartments began to rely on targeted applications of baits for pests such as ants and cockroaches instead of routine treatments of baseboards. Eliminating residual pesticide applications made it easier for bed bugs to travel safely from the luggage to the bed and successfully start an infestation.

The change in pest management practices coincided with a general increase in bed bug activity on a world-wide basis. The increased prevalence of bed bugs world-wide increased the frequency of encounters with bed bugs during travel resulting in a greater number of introductions into lodging facilities than in the past. This is demonstrated by the fact that most of the early infestations in the United States in the late 1990's were identified in hotel rooms.

Now that bed bugs are back, they are spreading throughout the United States at a rapid rate. Bed bugs are excellent hitch hikers. Once they are introduced into an environment they readily spread from an infested location to a new, previously uninfested location. Spending a single night in a bed bug infested environment is often all it takes pick them up and take them to a new destination.

Some of the more common dispersal mechanisms include overnight stays in bed bug infested quarters, the purchase of infested furniture (rental furniture, used/second hand furniture, reconditioned mattresses etc.), the acquisition of discarded items that are infested, and migration of bed bugs from one infested dwelling to another in multi-occupancy settings (apartments, college housing, medical facilities, senior communities etc.).

Lack of public awareness is a significant factor that has enabled bed bugs to spread throughout the United States at an exponential rate. Many people simply don't know that bed bugs even exist much less that they are a current pest problem. As a result people rarely think twice about picking up discarded furniture that is infested with bed bugs and bringing it into their homes.

Once bed bugs are introduced, it is not uncommon for infestations to go undetected for several months or more. The secretive habits of bed bugs are a big reason infestations are not detected earlier. Bed bugs are mostly active at night, coming out of tiny, obscure hiding places to feed on the blood of people as they sleep. Their bite is often painless so people are unaware that they have been bitten. Once they have finished eating a blood meal they retreat back to their hiding places where they remain undetected until it is time to feed again (often going several days to a week or more between blood meals).

Many people don't react to bed bug bites and those that do only develop bite symptoms after becoming sensitized from being repeatedly bitten. It is not uncommon for people to have delayed reactions of several weeks or more. Even when symptoms do occur, they are often confused with poison ivy, scabies, allergic reactions, etc. All of these factors have allowed bed bugs to become well established before the occupants of the infested structure identify the infestation.

Once discovered, bed bugs are prolific and notoriously difficult to eradicate. Female bed bugs lay their eggs in secluded areas. They deposit one, two or more eggs per day. The eggs are tiny, whitish, and difficult to see on most surfaces without magnification (individual eggs are about the size of a pinhead).

When first laid, bed bug eggs are sticky, causing them to adhere to surfaces. Newly hatched nymphs are pale tan-colored and are no bigger than a pinhead. The immature nymphs resemble the adults, but are smaller and lighter in color. As they grow, they molt and shed their skin, up to five times before reaching maturity.

Bedbugs are perversely resilient. Nymphs can survive months without feeding and the adults can live for more than a year. Leaving a premises unoccupied rarely eradicates an infestation. Also, even though bed bugs prefer to feed on humans, they will also bite other warm-blooded animals, including dogs, cats, birds, chickens and rodents.

Conventional bed bug treatments can be divided into the following categories: (1) chemical treatment, (2) temperature treatment, and (3) mechanical treatment. The first refers to the use of pesticides or other chemicals to control bed bugs. Though commonly used, the pesticide approach often requires multiple visits, typically three to five, and is not always effective due to pesticide resistance and dispersal of the bed bugs.

Studies of bed bug populations indicate that they have developed substantial resistance to pesticides such as DDT and organophosphates. They are also largely resistant to many common pesticides such as pyrethroids.

Bed bugs are not only resistant to many common pesticides, but their pesticide resistance appears to be increasing dramatically. Bed bug populations sampled across the United States showed a tolerance for pyrethroids several thousand times greater than laboratory bed bugs. Genetics studies have also shown that the spread of insecticide resistance is rapid.

Another problem with pesticides is that they may cause the bed bugs to disperse to neighboring areas of a structure, spreading the infestation. The problem of pesticide resistance in bed bug populations increases the opportunity for them to spread.

Pesticide treatment is rarely sufficient by itself to eradicate bed bugs. In many situations, individuals must dispose of furniture and other infested materials. These items should be broken or marked to prevent them from being unintentionally recycled and furthering the spread of bed bugs.

Individuals are also required to take other drastic and intrusive measures such as placing all their clothes and bedding in plastic bags in the sun or running them through the dryer. This is a major inconvenience.

Pesticide treatment of mattresses is problematic at best. Spraying the mattress with a pesticide is undesirable because the room must be ventilated and sufficient time must be given after application before the mattress can be used again. There is also a significant risk that the user will have an allergic reaction to the chemicals. Other health risks include cancer and acute neurotoxicity.

Temperature treatments include both hot and cold treatments. Bed bugs are highly temperature sensitive, adapted to live in sheltered indoor places with stable temperature and no air flow. They can be controlled by raising or lowering the temperature of the environment.

Cold treatment refers to subjecting bed bugs to freezing temperatures below 32° F. Subjecting bed bugs to these temperatures will cause population numbers to drop. The downside of cold treatment is that cold temperatures must be maintained for one to two weeks to be effective. These temperatures also risk freezing water pipes causing even more problems.

Cold treatments rarely result in complete eradication of a bed bug population. It is unclear whether this is because there always will be very small sheltered places where founder populations can survive, or whether it is due to re-infestation from smaller populations elsewhere in the room, adjacent rooms, or from outside. Bite incidence usually begins to increase around three weeks after the cooling regime is discontinued, and returns to the untreated level within a few months.

Heat treatment refers to subjecting bed bugs to high temperatures, preferably above 120° F. Bed bugs and their eggs are highly susceptible to these temperatures and will die within minutes or hours instead of days or weeks with cold treatment.

One common form of heat treatment is whole room or premises heat treatment. This treatment involves raising the room temperature to or above the kill temperature for bed bugs, which is around 113° F. This is usually done by professionals and can be performed on a single dwelling or an entire building.

Some of the drawbacks for heat treatments include the amount of time required to bring core temperatures high enough to effectively kill bed bugs that have taken refuge inside various materials. Bed bugs retreat into cracks and crevices in walls, ceilings, and floors to escape the treatment resulting in later infestations. The biggest problem, however, is that this treatment is very expensive. It can cost thousands of dollars just to treat a relatively small dwelling.

Another method of heat treatment is to kill bed bugs in a clothes dryer. Infested clothes and bedding is first washed in hot water with laundry detergent then placed in the dryer at high heat. Although this can be an effective way to treat clothes and bedding, it does not eliminate bed bugs in the mattress, bed frame, furniture, and surrounding environment. Also, treating materials in this fashion is labor intensive.

Steam treatment is another way to kill bed bugs with heat. Unfortunately, bed bugs hide in a variety of places, making steam treatment tedious, labor intensive, and time consuming. There is also the risk of the steam not penetrating materials enough to kill hidden bed bugs. The steam may also damage materials such as varnished wood, or cause mold from the moisture left behind. Effective treatment requires repeated and thorough steaming of infected materials such as the mattress, boxspring, bed frame, bed covers, pillows, not to mention other materials and objects within the infested room, such as carpets and curtains.

Another method of heat treating bed bugs involves putting infested items such as mattresses, box springs, and bed frames inside a heated trailer and then heating the items until the bed bugs are dead. Unfortunately, defects with the trailers used to heat the infested items have made this alternative less viable. For example, the trailers are heated with forced air, which makes it difficult or impossible to heat certain areas where the forced air cannot reach, places such as corners and locations where the infested items contact the wall of the trailer.

Mechanical treatment refers to other methods of treating bed bugs that do not involve the use of chemicals or temperature. This category of treatments includes physical isolation techniques, inorganic material treatments, vacuuming, mattress encasements, disposal of infected materials, and the like.

Physical isolation refers to isolating humans from the bed bugs. This includes techniques and devices such as bed bug proof mattress encasements (encase the infected mattress so bed bugs can't get out), bed leg moat devices, and other barriers. However, even with isolated beds, bed bug infestations persist if the bed itself is not free of bed bugs, or if it is re-infested, which could happen quite easily.

Inorganic materials such as diatomaceous earth can be used to manage a bed bug infestation, provided they are used in a dry environment. A fine dust-like layer of the inorganic material is placed in areas where bed bugs travel. The inorganic material has sharp edges that contact and cut the waxy outer layer of the bed bug's exoskeleton causing it to dehydrate and die.

Although inorganic materials can be effective, they can be dangerous if inhaled by the user. This is especially a problem when inorganic materials are used in dwellings that have small children or pets. Another problem with inorganic materials is that they are rarely completely effective on their own.

Disposal of items from the contaminated area can reduce the population of bed bugs and unhatched eggs. Removal of items such as mattresses, box springs, couches etc. is costly and usually insufficient to eradicate infestation because of eggs and adults hiding in surrounding areas. If the entire infestation is not treated new furniture is likely to be re-infested.

The improper disposal of infested furniture also facilitates the spread of bed bugs. Marking the discarded items as infested can help prevent infesting new areas. Items may also be sealed and stored until all eggs hatch and all larvae and adults have died, though bed bugs may live as long as 18 months without feeding.

Vacuuming helps reduce bed bug infestations, but does not eliminate bed bugs hidden inside walls, furniture, and other materials. Also, unless the contents of the vacuum are emptied immediately after each use, bedbugs can crawl out through the vacuum's hoses and re-establish themselves.

### SUMMARY

A number of representative embodiments are provided to illustrate the various features, characteristics, and advantages of the disclosed subject matter. The embodiments are provided largely in the context of a heated enclosure that is part of a cargo trailer. It should be understood, however, that many of the concepts may be used in a variety of other settings, situations, and configurations. For example, the features, characteristics, advantages, etc., of one embodiment can be used alone or in various combinations and sub-combinations with one another.

A system for heating items infested with bed bugs includes a heated enclosure capable of being heated to a temperature and for a duration that is sufficient to kill the bed bugs. The interior of the enclosure is heated to a set temperature and maintained at or above that temperature until the temperature of each infested item is high enough to kill the bed bugs.

The enclosure can have any suitable configuration. It is preferable for the enclosure to be portable to allow it to be moved to different infestation locations. In one embodiment, the enclosure is part of a vehicle such as a cargo trailer or a cargo truck. In another embodiment, the enclosure is part of a portable container such as a cargo or shipping container. Although it is preferable for the enclosure to be portable, it can also be part of a fixed structure such as a building.

The enclosure can be heated using any suitable heat source. It is preferable to use a hydronic heating system due to its efficiency and the relatively fast speed at which it can heat the interior. In general, a hydronic heating system is a system that uses a liquid as the heat transfer medium. A heater heats the liquid and the heat is transferred from the liquid to the interior of the enclosure using various methods.

The hydronic heating system can include a hydronic radiant heating system and/or a hydronic forced air heating system. A hydronic radiant heating system is a system that relies on radiant heat transfer to transfer heat into the interior of the enclosure. Radiant heat transfer refers to the delivery of heat directly from a hot surface to the interior via infrared radiation. The hydronic radiant heating system can supply heat directly to the floor, walls, and/or ceiling of the enclosure. It should be appreciated that the hydronic radiant heating system also relies heavily on convection and/or conduction to transfer heat into the interior of the enclosure.

A hydronic forced air heating system is a heating system that includes a heat exchanger and a blower. The heat exchanger is used to transfer heat from the liquid to the air and the blower is used to circulate the heated air through the interior of the enclosure. Preferably, the hydronic forced air heating system includes a hydronic furnace.

The hydronic heating system can include a heater that relies on combustion of gas, oil, wood, or the like to heat the liquid. It can also include other heaters such as electric heaters. It is preferable to use a gas-fired heater because it is the most cost effective and the necessary equipment such as gas tanks, is readily available. For example, the heater can burn propane or LP gas.

In one embodiment, the heater is a tankless water heater that is capable of modulating the heat output to the liquid. Tankless water heaters are preferred because they are the most economical to purchase and operate. Also, they require very little electricity so that the entire hydronic heating system can be operated with a single power connection to a 120 V outlet.

The hydronic heating system can include one or more portable radiant heating panels that allow the user to tailor the heat supply to match the items in the enclosure. The radiant heating panels can be selectively coupled and decoupled to one or more manifolds in the walls of the enclosure. The heating panel can then be placed in hard to heat locations such as between two mattresses, half-way through a pile of clothes, or the like.

The Summary is provided to introduce a selection of concepts in a simplified form that are further described below in the Detailed Description. The Summary and the Background are not intended to identify key concepts or essential aspects of the disclosed subject matter, nor should they be used to constrict or limit the scope of the claims. For example, the scope of the claims should not be limited based on whether the recited subject matter includes any or all aspects noted in the Summary and/or addresses any of the issues noted in the Background.

### DRAWINGS

The preferred and other embodiments are disclosed in association with the accompanying drawings in which:

FIG. 1 shows a front perspective view of a cargo trailer that includes a heated enclosure.

FIG. 2 shows a rear perspective view of the cargo trailer in FIG. 1.

FIGS. 3-4 show side perspective views of the cargo trailer in FIG. 1 with the side door open and the hydronic heating system in view.

FIG. 5 shows a rear perspective view of the cargo trailer in FIG. 1 with the rear doors open and the interior of the heated enclosure in view.

FIG. 6 shows a perspective view of the interior of the heated enclosure from FIG. 5.

FIG. 7 shows a configuration of a hydronic heating system that includes a hydronic furnace in a primary circulation loop and a heater and radiant tubing loops each in their own secondary circulation loops.

FIG. 8 shows a configuration of the hydronic heating system that includes the hydronic furnace and the radiant tubing loops in a primary circulation loop and the heater in a secondary circulation loop.

FIG. 9 shows a configuration of the hydronic heating system that includes the hydronic furnace, the heater, and the radiant tubing loops all in a primary circulation loop.

FIG. 10 shows a configuration of the hydronic heating system shown in FIG. 7 that includes two heaters positioned to heat the water in the secondary circulation loop in parallel.

FIG. 11 shows a control panel that is can be used to control the hydronic heating system.

FIG. 12 shows one embodiment of the construction of the walls of the cargo trailer.

FIGS. 13-15 show different configurations of radiant heating panels that can be coupled to the floor, walls, and ceiling of the enclosure.

FIGS. 16-17 show the construction of the radiant heating panels in FIGS. 13-15 including the manner in which radiant tubing fits in the grooves in the panels.

FIG. 18 shows one embodiment of a bed bug trap that can be placed between the floor and the legs of furniture.

FIG. 19 shows a front perspective view of a box truck or cargo truck that includes a heated enclosure.

FIG. 20 shows a front perspective view of a shipping container that includes a heated enclosure.

FIG. 21 shows a perspective view of a portable heating panel that can be selectively coupled to and decoupled from the hydronic heating system.

FIGS. 22-25 show the radiant tubing layout for the cargo trailer used in the Examples.

### DETAILED DESCRIPTION

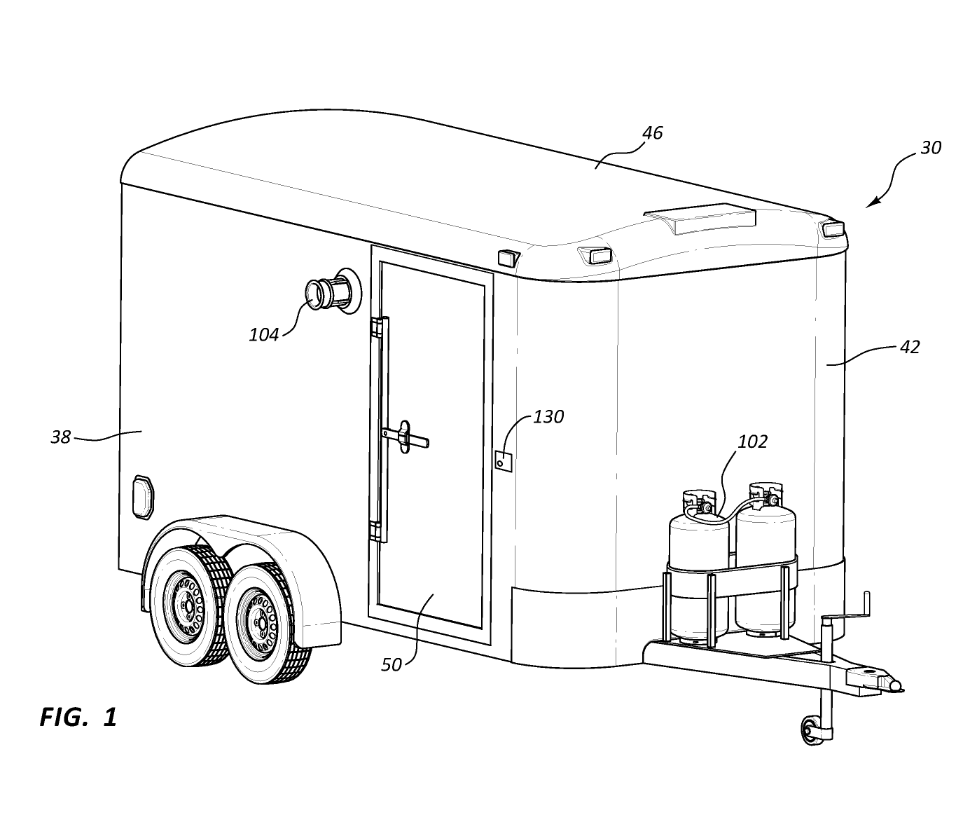

Referring to FIG. 1, a cargo trailer 30 includes a heated enclosure 32 that is capable of heating various items infested with bed bugs to a temperature that is sufficient to kill the bed bugs. The cargo trailer 30 includes a hydronic heating system 34 that is used to heat the enclosure 32.

It should be appreciated that although the heated enclosure 32 is described in the context of a cargo trailer 30, it can take many other forms. It is preferable that the enclosure 32 is portable so that it can be easily transported from one infestation site to the next. In one embodiment, the enclosure 32 is part of a vehicle such as a box or cargo truck or storage container (e.g., storage pod, shipping container). In other embodiments, the enclosure can be fixed in place as part of a building or other structure.

The cargo trailer 30 includes a floor 36, side walls 38, 40, front wall 42, back wall 44, and a roof/ceiling 46. The side walls 38, 40 are perpendicular to the front and back walls 42, 44 and extend along the side of the trailer from the front wall 42 rearward to the back wall 44. The back wall 44 includes a set of double doors 48 and the side wall 38 includes an auxiliary door 50 near the front of the cargo trailer 30.

It should be appreciated that the double doors 48 can be replaced with a single door, ramp door, roll-up door or the like. A ramp door is preferred because it makes it easy to load and unload the enclosure 32. The ramp door can include a lifting mechanism (cables connected to a tensioning device) that helps lift the ramp door upward to make it easier to close. Alternatively, a separate ramp can be provided for use with the other type of doors so that the user can easily load and unload the enclosure 32. In one embodiment, the ramp (or ramps) is configured to be stored under the floor 36 of the cargo trailer 30.

The floor 36, side walls 38, 40, front wall 42, back wall 44, and roof/ceiling 46 are preferably insulated to limit heat losses from the enclosure 32. Without adequate insulation, the high temperatures in the enclosure 32 would be difficult to maintain, especially in the winter in colder climates.

In one embodiment, the floor 36, side walls 38, 40, front wall 42, back wall 44, and roof/ceiling 46 are insulated with spray foam insulation and/or rigid board insulation. Spray foam insulation is preferred because of its high R-values and superior insulation characteristics. Unlike most other forms of insulation, spray foam adheres to structural materials in a way that prevents air and/or vapor movement. It also provides a substantial amount of structural integrity to the cargo trailer 30. An inch of spray foam (closed cell) provides roughly the same amount of structural integrity as a sheet of ¾ inch plywood.

The spray foam can be closed cell or open cell spray foam insulation. As their names indicate, the difference lies in whether the cells or bubbles in the foam are closed and sealed or open and broken. Closed cell spray foam is generally a hard rigid material that encapsulates gases in the cells or bubbles. Open cell foam (polyisocyanurate) is generally a soft pliable material with open cells filled with air. Closed cell foam has a higher R-value, greater structural strength, and greater resistance to air leakage and is preferred for these reasons. In one embodiment, the cargo trailer 30 is insulated with closed cell polyurethane spray foam.

It should be appreciated that other types of insulation can also be used to insulate the cargo trailer 30. Examples of suitable insulation include fiber glass, cellulose, mineral, cementitious, and the like. This insulation can be in the form of blown-in insulation, batts, rolls, loose-fill, or the like.

The insulation can be applied in any suitable manner. In one embodiment, the cargo trailer 30 is a conventional cargo trailer 30 available from a variety of cargo trailer manufacturers. The floor 36 can be insulated by creating joists with 2X4s over the original floor surface and then positioning insulation in the space between the 2X4s. Alternatively, the floor 36 can be insulated by positioning the insulation underneath the original floor.

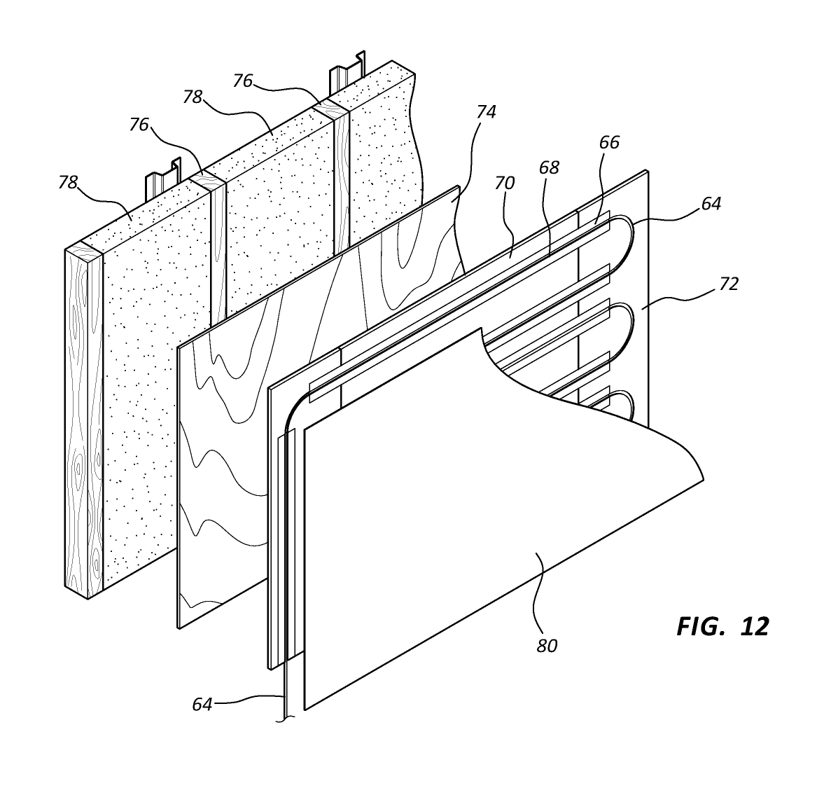

The walls 38, 40, 42, 44 of an off-the-shelf cargo trailer 30 may only be an inch or so deep, which corresponds to the size of the vertical structural members in the wall. If an inch of insulation is not enough, then the walls 38, 40, 42, 44 can be framed with 2X3s to add an additional two inches of depth for a total depth of three inches. The insulation 78 is positioned between the wall structural members and 2X3 studs (FIG. 12).

The roof/ceiling 46 can be framed out with wood rafters to create a space between the rafters and the top of the roof. This space can be filled with insulation.

The cargo trailer 30 can be any suitable size. In one embodiment, the cargo trailer 30 includes a cargo storage area (measured on the inside or outside) that is at least approximately 4 feet wide and at least approximately 6 feet long. In another embodiment, the cargo storage area can have any dimension from approximately 4 feet to approximately 8 feet wide and approximately 6 feet long to approximately 45 feet long.

It is preferable for the cargo trailer 30 to be capable of holding a substantial amount of weight to account for the additional weight of the hydronic heating system 34. This can be accomplished using a single axle, dual axles, or triple axles. In one embodiment, the cargo trailer 30 is at least a dual axle and is capable of holding at least approximately 500 to approximately 3000 lbs of extra weight.

The hydronic heating system 34 includes a heater 52 configured to heat a liquid that is subsequently used to transfer heat to the interior of the enclosure 32. The heater 52 can be any suitable heater that is capable of heating water to at least approximately 120° F.

The heater 52 can be configured to modulate the amount of heat provided to the liquid. At startup, the heater 52 may operate near its maximum output because the liquid is cold and may require more heat to get it up to temperature. Later when the liquid is warmer the heater 52 needs to produce less heat so it operates at a lower output. In one embodiment, the heater 52 is configured to modulate its heat output between 5,000 BTUs/hr and 400,000 BTUs/hr.

In one embodiment, the heater 52 is a tankless water heater. In another embodiment, the heater 52 is a boiler. The difference between a tankless water heater and a boiler is that the former is designed for relatively low flow rates (typically up to 8 gallons per minute or gpm) and large temperature changes (heat 60° F. water to 140° F. water) while the latter is designed for relatively high flow rates (10 gpm and up) and small temperature changes (heat water from 90° F. to 110° F.). The flow rates in the hydronic heating system 34 are such that either a tankless water heater or a boiler could be used.

The heater 52 can use any suitable energy source to heat the liquid. Examples of suitable energy sources include gas (propane, LP, natural gas), electric (120V, 240V, 480V, and so forth), oil, wood, and the like. It is preferred to use propane gas because it is economical and a widely used and accepted energy source for portable vehicles such as RVs. In one embodiment the heater 52 is a direct vent heater that burns gas such as propane to heat the liquid. The propane can be stored in one or more propane tanks 102 positioned at the front of the cargo trailer 30.

In one embodiment, the heater 52 can be a condensing water heater or boiler. Condensing heaters offer the highest efficiency by using the waste heat in the flue gases to pre-heat the cold water and/or combustion air entering the heater. The condensate produced by the heater can be drained through a hole in the floor 36 of the cargo trailer. Also, the condensate trap can include a valve that opens when power is not present (normally open valve) so that the condensate drains from the trap when the hydronic heating system 34 is turned off. This prevents the condensate trap from freezing in colder climates.

The heater 52 can be an electric heater. Electric heaters have the advantage of being fully modulating and not requiring any venting. The downside of electric heaters is that they require large capacity electrical connections (240V and up) to supply the required amount of heat. These connections are not readily available in most locations that are susceptible to bed bug infestations. A portable generator could be used to provide the needed power, but it would likely be large and expensive.

The hydronic heating system 34 can also include multiple heaters 52. The number of heaters depends largely on the desired heat output of the hydronic heating system 34. Two or more heaters 52 can be used together in a parallel relationship to heat the liquid. In this arrangement, each heater 52 draws liquid from a common return liquid source and outputs heated liquid to a common heated liquid supply source.

In one embodiment, the hydronic heating system 34 includes a first heater that is combustion based such as a tankless water heater and a second heater that is an electric heater. The first heater provides the heat to initially get the liquid and the cargo trailer 30 up to temperature. The second heater provides the heat to maintain the cargo trailer 30 at the desired temperature. This configuration reduces wear on the first heater by reducing or eliminating short cycling—i.e., the heater repeatedly comes on for short periods of time because only a small amount of heat is needed each time.

The hydronic heating system 34 includes a hydronic radiant heating system and a hydronic forced air heating system. The radiant heating system relies on radiant heat transfer to supply heat to the interior of the enclosure 32. The radiant heating system can supply heat to the interior by heating the floor 36, side walls 38, 40, front wall 42, back wall 44, and/or roof/ceiling 46.

One of the advantages of using a radiant heating system is that there are no cold spots on any of the interior surfaces of the enclosure 32. The bed bugs have no place to hide or escape to. In contrast, a system that uses only forced air will produce cold spots where a mattress sits on the floor or leans up against a wall. The enclosure 32 can be loaded with more items because the items can be placed flush up against the walls without worrying about creating cold spots where bed bugs can survive.

The floor 36, walls, 38, 40, 42, 44, and/or the ceiling 46 are heated by radiant tubing. In one embodiment, radiant heating panels are used to facilitate heat transfer from the liquid in the radiant tubing to the floor 36, walls, 38, 40, 42, 44, and/or the ceiling 46. The radiant heating panels include a channel that receives the tubing and a heat transfer material that facilitates rapid transfer of the heat to the interior of the structure. The heat transfer material can include aluminum.

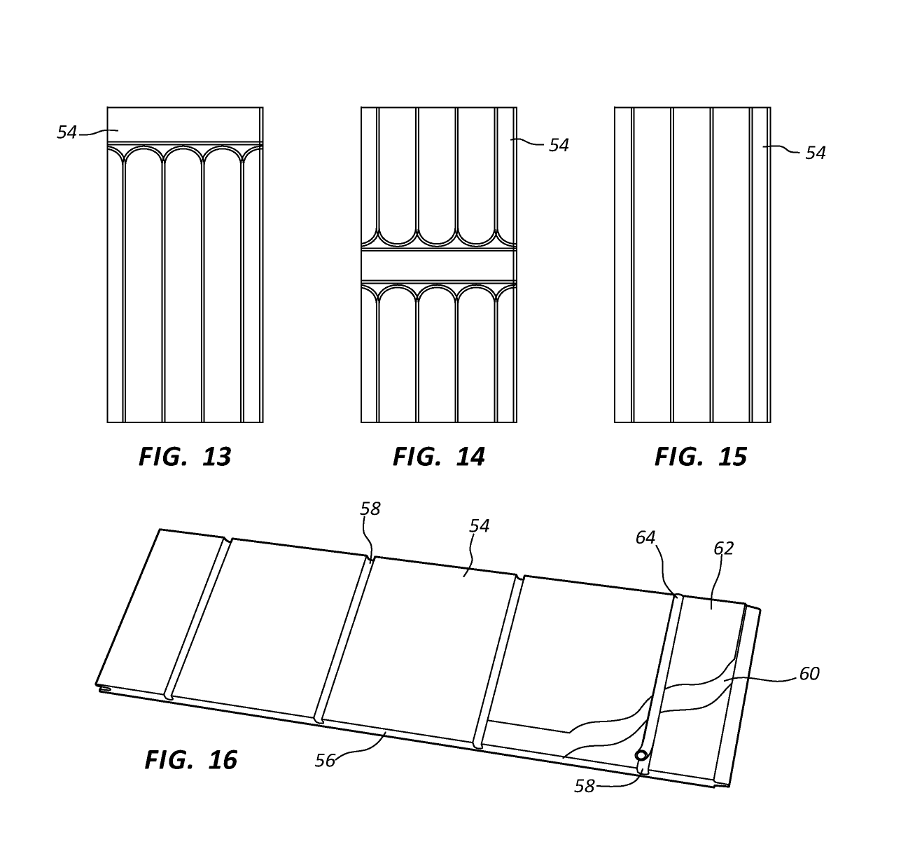

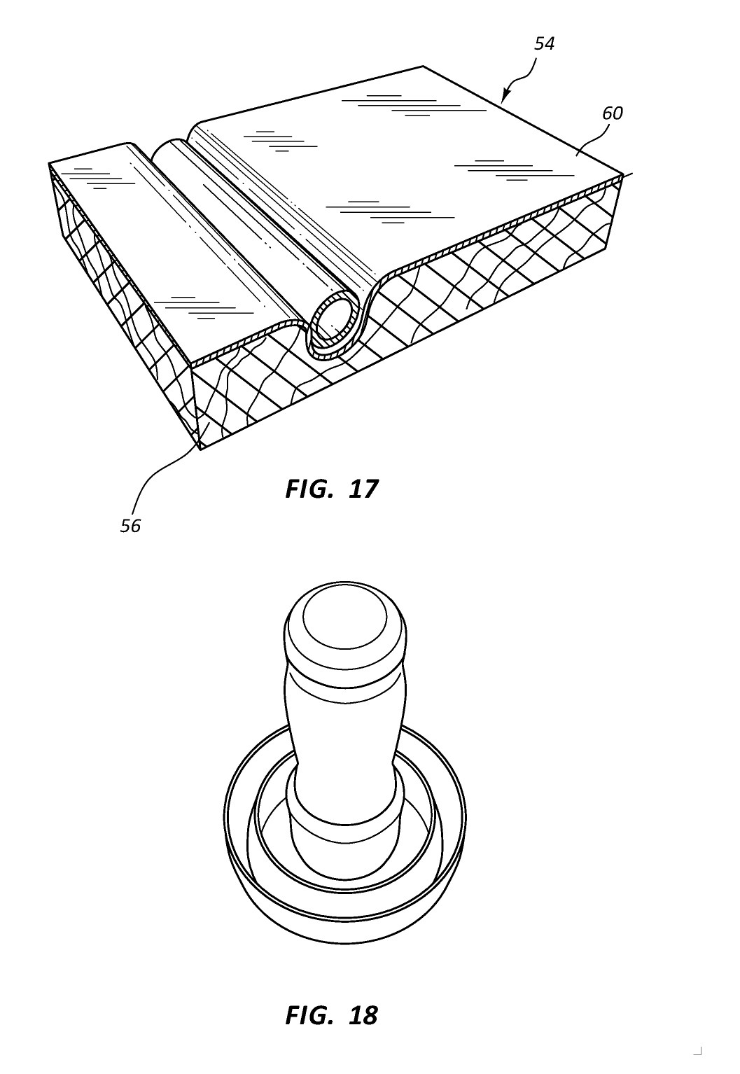

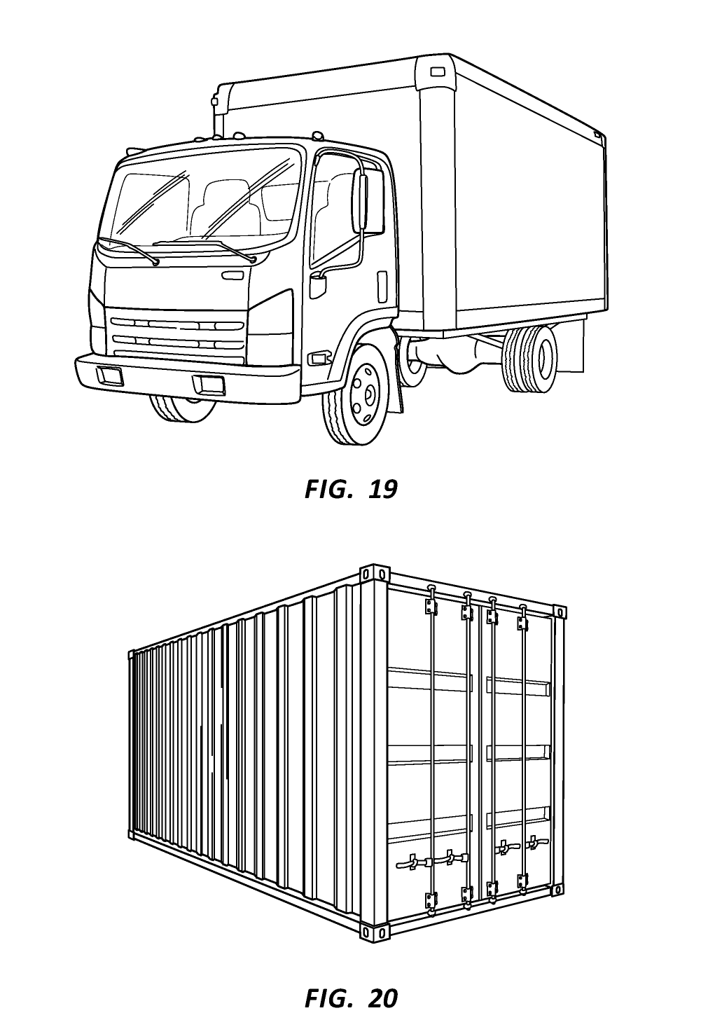

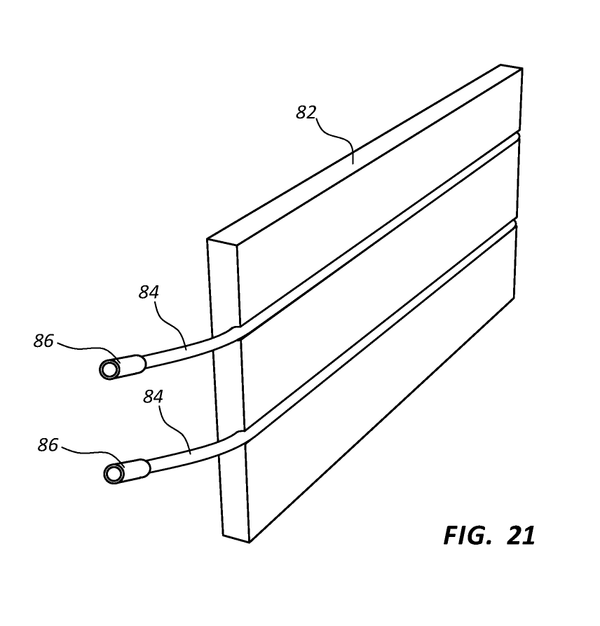

FIGS. 13-17 show one embodiment of a radiant heating panel 54 that includes a solid base 56 with channels or grooves 58 in it, and clad with a layer of aluminum 60. The aluminum is covered with paint 62 to reduce glare and make it easier to install. This type of radiant heating panel 54 can be coupled directly to the floor, wall, and ceiling studs in the cargo trailer 30. This type of panel 54 provides a solid surface that can handle the abuse of moving items in and out of the enclosure 32 day after day. The radiant tubing 64 fits flush in the channels 58 in the manner shown in FIGS. 16-17.

FIGS. 13-15 show the different types of radiant heating panels 54 that can be used to make the floor 36, walls 38, 40, 42, 44, and/or the ceiling 46. The radiant heating panel 54 shown in FIG. 14 can be cut in half to form end pieces. The radiant heating panels 54 include a tongue a groove to provide added structural strength and make them easier to install. One example of a radiant heating panel 54 can be found in U.S. Pat. No. 5,788,152, which is hereby incorporated by reference in its entirety. A radiant heating panel 54 configured in the manner shown in FIGS. 13-17 can be obtained from Warmboard.

As shown in FIGS. 16-17, the aluminum layer 60 is positioned between the radiant tubing 64 and the underlying base material 56. As the radiant tubing 64 is heated by the liquid, the heat is transferred to the aluminum layer 60 and conducted outward. The aluminum is provided as a continuous, unbroken layer on each panel 54 to facilitate good conduction of the heat away from the radiant tubing 64.

It should be appreciated that other types of radiant heating panels can also be used. For example, the radiant heating panel can include polystyrene or some other insulator as the base material. The polystyrene is then covered with a layer of aluminum similar to that shown for radiant heating panels 54. Radiant heating panels having this configuration are available from Roth USA as Roth panels.

It should also be appreciated that any type of radiant tubing 64 can be used with the radiant heating panels 54 (or with any other radiant heating application). For example, the radiant tubing 64 can include PEX-AL-PEX tubing (two layers of crosslinked polyethylene tubing that sandwich a layer of aluminum) or PEX tubing. Other types of tubing can be used as well. The radiant tubing 64 can be ⅜ inch, ½ inch, or ¾ inch tubing (nominal internal diameter).

The floor 36, walls 38, 40, 42, 44, and the ceiling 46 can be heated using other methods that do not include panels. FIG. 12 shows one embodiment where the radiant tubing 64 is positioned in separate heat transfer plates 66. The heat transfer plates 66 have a flat shape with a channel 68 that extends outward. The channel 68 is configured to receive the radiant tubing 64. The heat transfer plates 66 are roughly similar in shape to the aluminum layer 60 on the radiant heating panels 54. One example of the heat transfer plates can be found in U.S. Pat. No. 5,454,428, which is hereby incorporated by reference in its entirety.

The heat transfer plates 66 are positioned between support sleepers 70 and return bends 72 which can be made of wood or foam board insulation. The sleepers 70 and return bends 72 provide support for and fill the space between the heat transfer plates 66. The support sleepers 70 and the return bends 72 are coupled to a support layer 74 that can be plywood or the like. The support layer 74 is coupled to the wood studs 76.

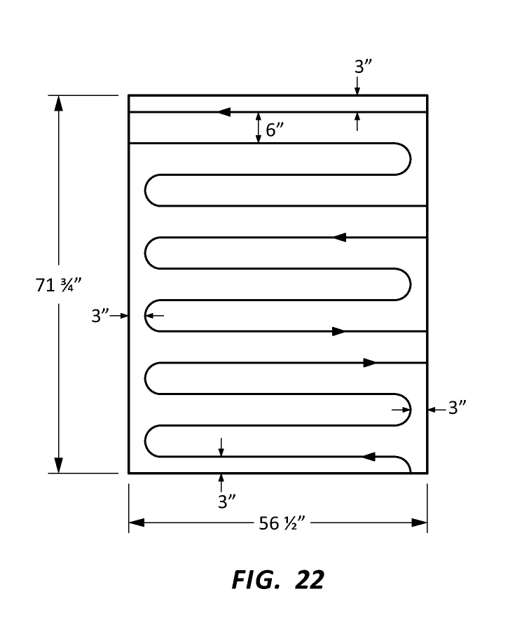

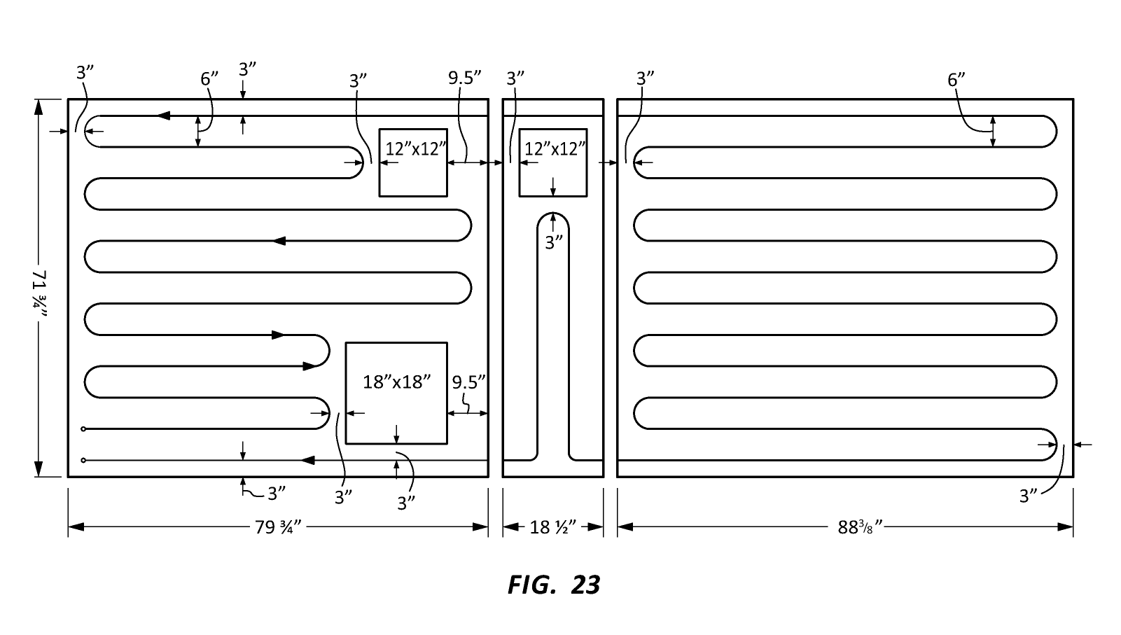

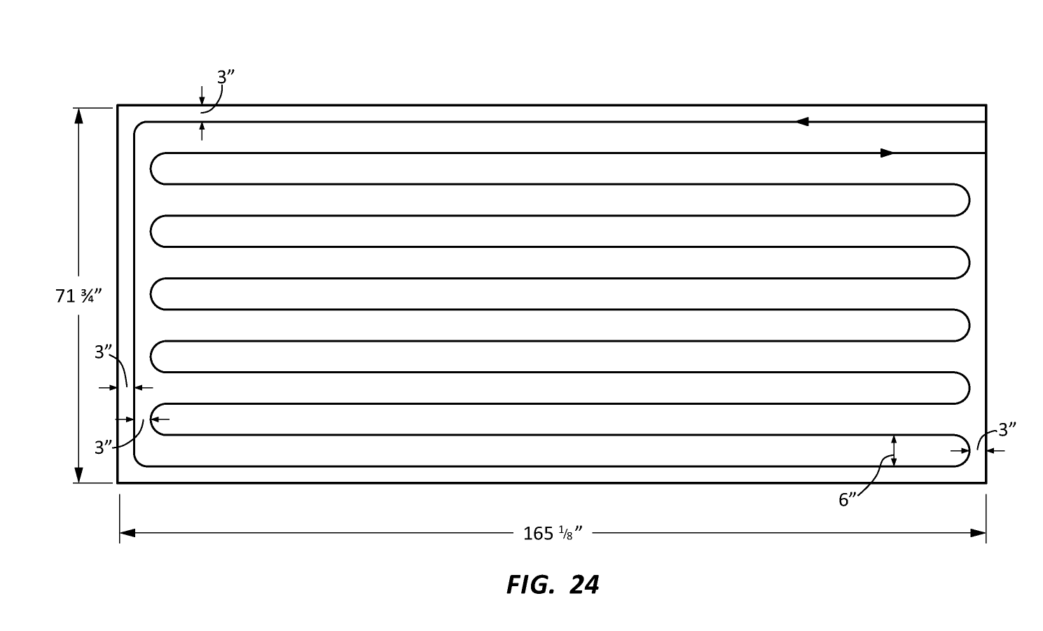

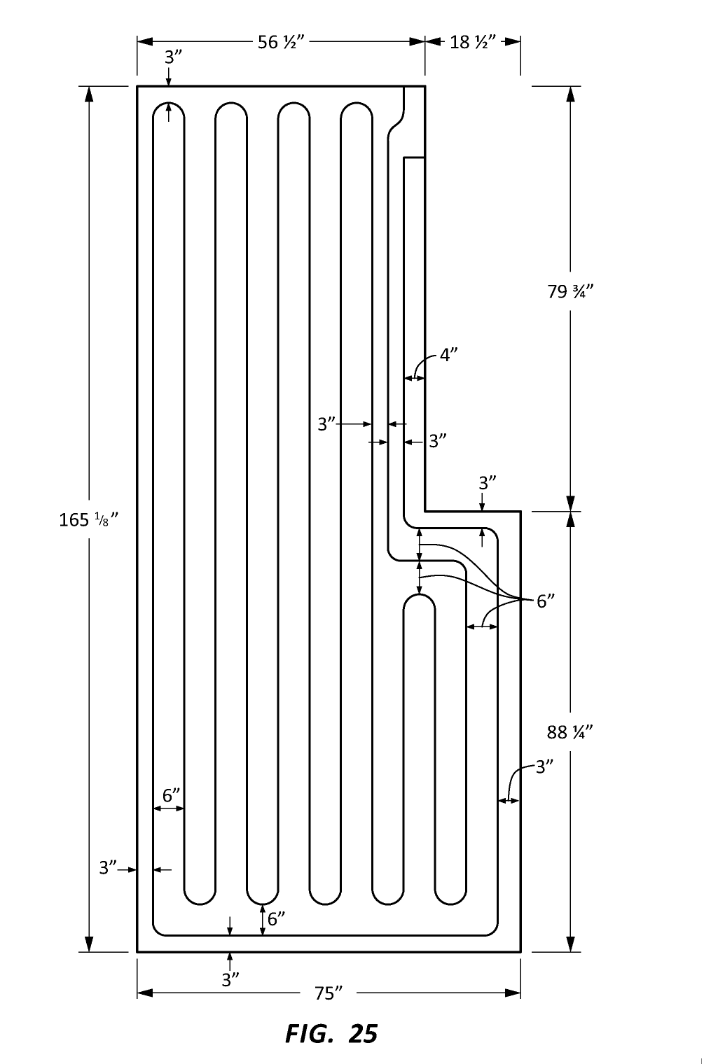

In one embodiment, the radiant heating system is configured so that the supply for each radiant loop extends around the perimeter of the floor 36, wall 38, 40, 42, 44, or ceiling 46 to force the beds bugs towards the center. This configuration increases the kill rate by keeping the bed bugs from trying to escape through cracks around the doors 48, for example. FIGS. 22-25 show one example of radiant tubing layouts where the supply liquid forms a perimeter around at least three sides of the floor 36 and wall 40.

The floor 36, walls 38, 40, 42, 44, and/or the ceiling 46 are clad with a conductive material such as aluminum sheets or plates. Using a highly conductive material makes it possible to transfer more heat to the items in the interior of the compartment 32 faster. In one embodiment, the interior of the walls 38, 40, 42, 44 and the doors 48, 50 are clad with aluminum sheet or roll material that is approximately 0.010 to approximately 0.100 inches thick and the floor 36 is clad with aluminum sheet or plate material that is approximately 0.050 to approximately 0.250 inches thick. In one embodiment, the aluminum on the floor 36 has a diamond pattern on it to provide increased traction.

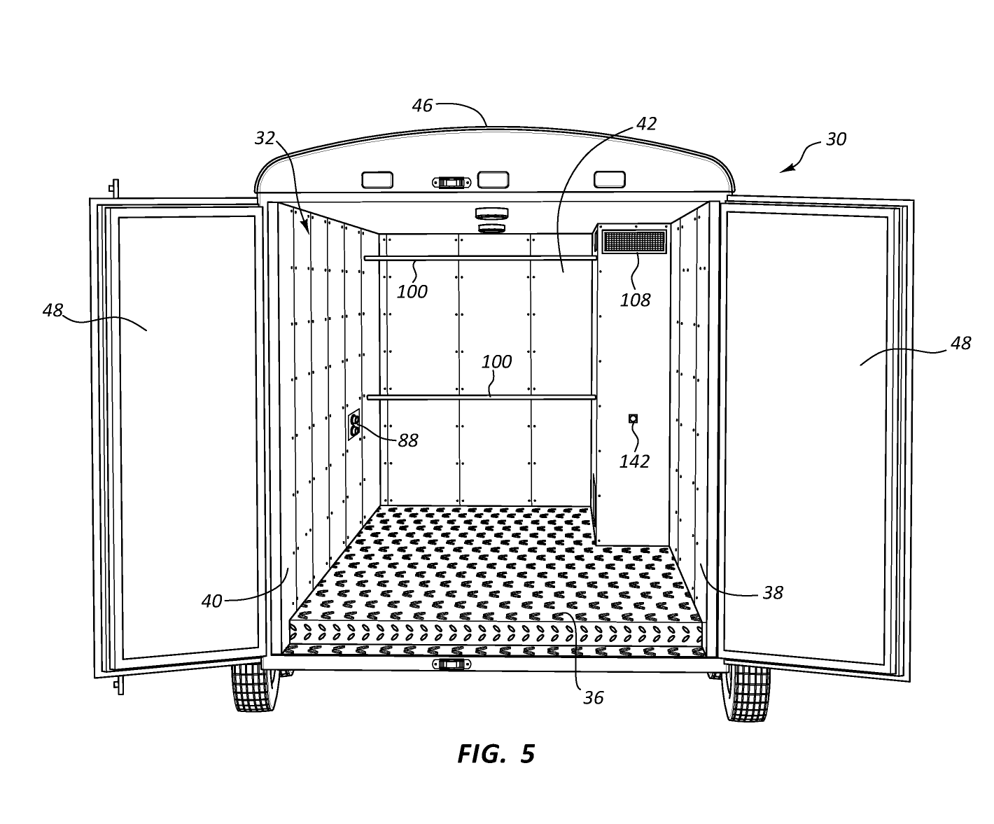

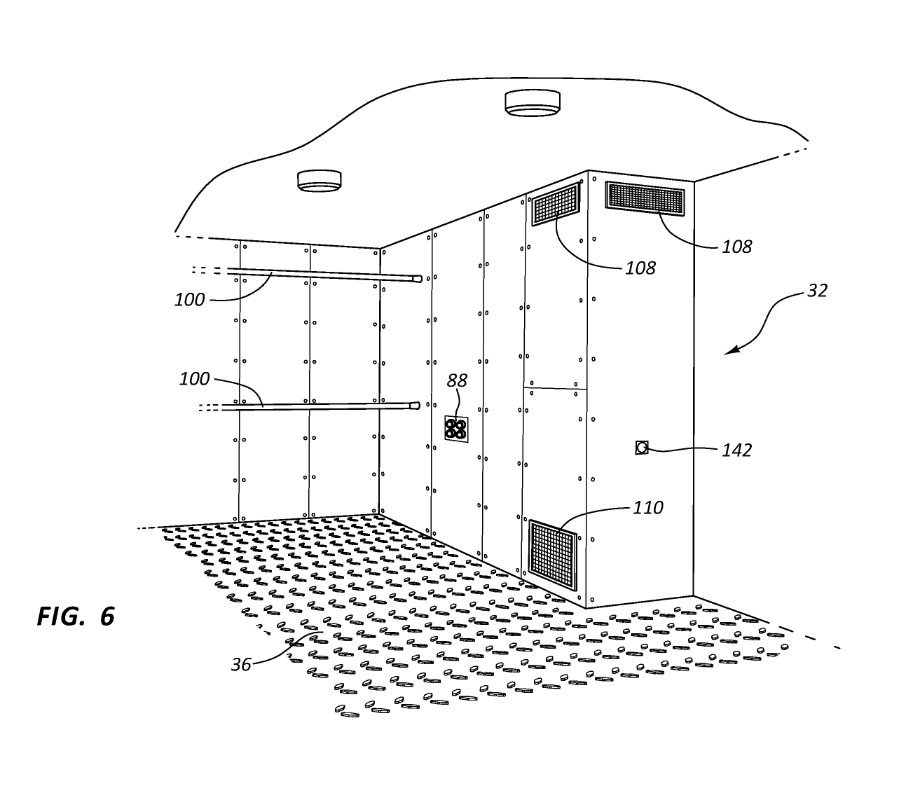

In one embodiment, the walls 38, 40, 42, 44 can include slat wall, pegboard, or some other system that allows items to be removably hung on the walls 38, 40, 42, 44. For example, shelves and clothing rods could be removably hung parallel or transverse to the specific wall 38, 40, 42, 44. The shelves and clothing rods can also be permanently attached. FIGS. 5-6 show one example of clothing rods that can be removably or permanently coupled transverse to the walls 38, 40.

Turning to FIG. 21, the radiant heating system can also include portable radiant heating panels 82. The portable heating panels 82 can be made by coupling two of the radiant heating panels 54 together so that the aluminum cladding on the panels face outward on both sides. Radiant tubing 84 extends through the channels on each side and out the end of the portable radiant heating panels 82. The overall panel 82 can also be enclosed in a conductive material such as aluminum. In one embodiment, the panel is clad in aluminum sheeting or plate material.

The radiant tubing 84 can be the same or different than the radiant tubing 64. In one embodiment, the radiant tubing 84 is more resilient and flexible than the radiant tubing 64 to make it easy to handle and manipulate the portable radiant heating panels 82.

The portable radiant heating panel 82 is configured to be easily coupled to and decoupled from the radiant heating system. In one embodiment, the portable radiant heating panels 82 include couplers 86 that are configured to couple to corresponding couplers 88 positioned in the walls 38, 40, 42, 44 of the enclosure 32. In one embodiment, the couplers 86, 88 can be a quick-release type coupling that allows very little or no liquid to escape when they are coupled together or taken apart (dry break couplings).

When the couplings 86, 88 are coupled together, the portable radiant heating panel 82 is in fluid communication with a radiant loop that includes the heated liquid. The liquid passes through the radiant tubing 84 and thereby heats the portable radiant heating panel 82.

In one embodiment, the couplings 88 are supplied by a separate radiant loop dedicated to providing liquid to the couplings 88. In other words, the radiant loop that supplies liquid to the couplings 88 does not supply liquid to heat the floor 36, walls 38, 40 42, 44, or ceiling 46. It is a separate loop that extends from the radiant loop supply back to the radiant loop return.

In one embodiment, the couplings 88 are coupled to a manifold that is positioned in the wall 38, 40, 42, 44. A manifold can be used to allow multiple portable radiant heating panels 82 to be coupled to the same location on the wall 38, 40, 42, 44. It should be understood that a manifold includes a supply manifold and a return manifold and that one of the couplers 86 is coupled to the supply side and one is coupled to the return side. The radiant loop that supplies the manifold is only closed when one of the portable radiant heating panels 82 is coupled to the manifold. Otherwise, the loop is open and no fluid flows through it.

In another embodiment, the liquid supplied to the portable radiant heating panels 82 is different than the liquid that is heated by the heater 52. The liquid in the heater 52 may include an antifreeze material such as methanol that would be preferable to minimize exposure to when coupling and uncoupling the portable heating panels 82 with the couplings 86, 88.

In this situation, the radiant heating system can include a heat exchanger that transfers heat from the first liquid that passes through the heater 52 to a second liquid that passes through the portable heating panels 82. In one embodiment, the second liquid includes water and a mixture of propylene glycol or ethanol. Of course, it is also possible to use the same liquid that passes through the heater to pass through the portable radiant heating panels 82.

The portable radiant heating panels 82 are useful because they can be positioned in hard to heat areas such as between horizontally or vertically stacked mattresses to provide an additional source of heat to kill the bed bugs. This improves the speed and efficiency of the process of heating the enclosure 32 and killing the bed bugs.

The hydronic forced air heating system includes a hydronic furnace 90 that is configured to receive the heated liquid from the heater 52, pass it through a liquid to air heat exchanger, and then blow it through ductwork 98 into the enclosure 32. The hydronic furnace 90 includes a liquid to air heat exchanger 92 and a blower 94. It also includes a circulating pump 96.

The hydronic furnace 90 blows heated air into the enclosure 32 through supply openings or registers 108 located near the ceiling 46 and draws return air through the return opening or register 110 located near the floor 36. The return air is drawn right into the hydronic furnace 90 through an opening in the side of the furnace housing.

The hydronic heating system 34 can be configured to heat the items in the cargo trailer 30 to a temperature that is sufficient to kill bed bugs. According to one study, the temperature needed to kill bed bugs is given as follows: adults and nymphs will die if exposed to 113° F. for 15 minutes; eggs will die if exposed to 113° F. for 60 minutes; all stages (adults, nymphs, and eggs) will die if exposed to 115° F. for 7 minutes.

According to another study, the temperature needed to kill bed bugs is given as follows: adults will die if exposed to 113° F. for 90 minutes; eggs will die if exposed to 113° F. for 8 hours; adults will die if exposed to 118° F. for 2 minutes; eggs will die if exposed to 118° F. for 90 minutes; adults and eggs will die if they are exposed to 122° F. (for any amount of time). According to the National Pet Management Association: all stages die if exposed to 113° F. for 7 hours; 118° F. for 90 minutes; or 122° F. for less than a minute.

In one embodiment, the hydronic heating system is configured to heat the interior of the enclosure to at least approximately 115° F., at least approximately 120° F., at least approximately 125° F., at least approximately 130° F., at least approximately 135° F., at least approximately 140° F., at least approximately 145° F., or at least approximately 150° F.

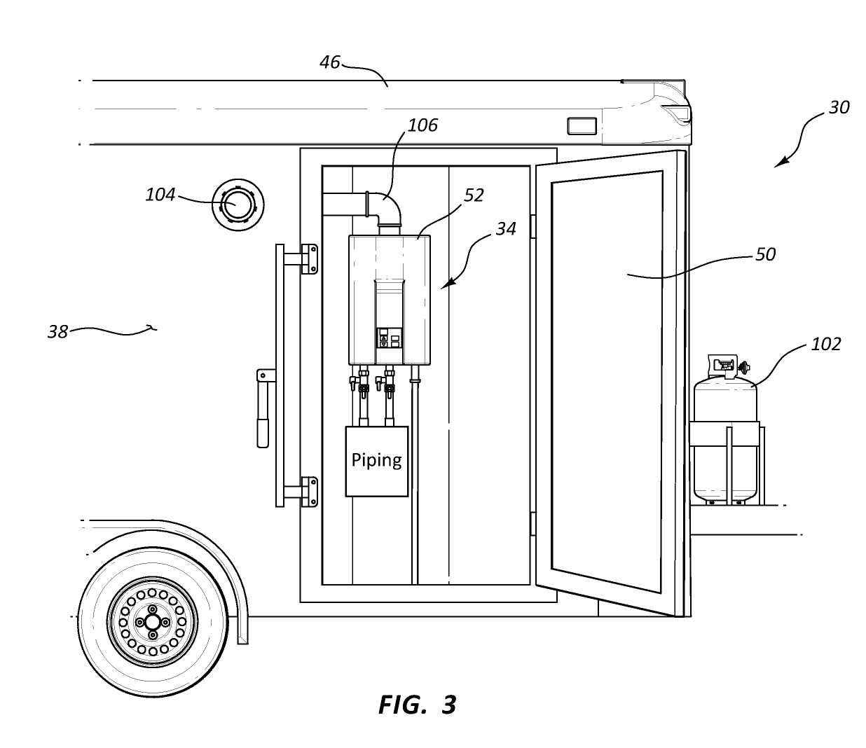

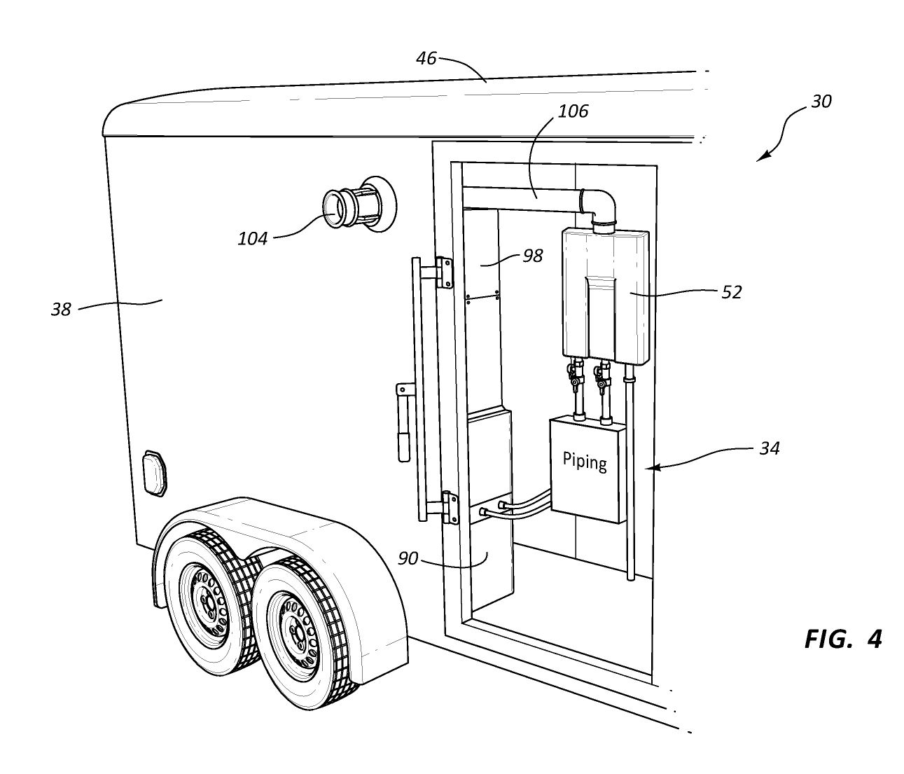

Referring to FIGS. 3-4, the heater 52 and the hydronic furnace 90 are positioned in a separate compartment of the cargo trailer 30 with its own door 50. This makes it easy to access and service the heating equipment.

The heater 52 is configured to burn propane and vent the exhaust through out of the compartment by way of vent piping 106 and a vent 104. In one embodiment, the heater 52 is a direct vent apparatus meaning it draws air in from outside and vents the exhaust outside. In one embodiment, the vent piping 106 includes two concentric passageways with the interior one containing the exhaust and the exterior one including the incoming air. The heat from the exhaust helps to heat the incoming air to facilitate better combustion.

In another embodiment, the heater 52 and the hydronic furnace 90 can be provided as a separate modular unit that slides to the front of the enclosure 32. So instead of the heater 52 and the hydronic furnace 90 being in a separate compartment that extends lengthwise down the side of the cargo trailer 30, they can be in a modular unit that extends transverse across the front of the cargo trailer. One of the walls of the modular unit would form the front wall of the enclosure (and it would have a door in it to allow access to the heater 52 and hydronic furnace 90 by way of the enclosure 32).

This design is desirable because it allows the modular unit with the heater 52, hydronic furnace 90, and associated piping to be fabricated separately and then inserted as a whole into the enclosure 52. The modular unit can be secured in place with screws or nails and then the only things that need to be connected are the radiant loops and the vent piping 106 for the heater 52. In this situation, the vent piping 106 extends out the front wall 42, makes a 90 degree turn, and terminates. The turn is included to prevent air from blowing directly into the vent when the cargo trailer 30 is moving.

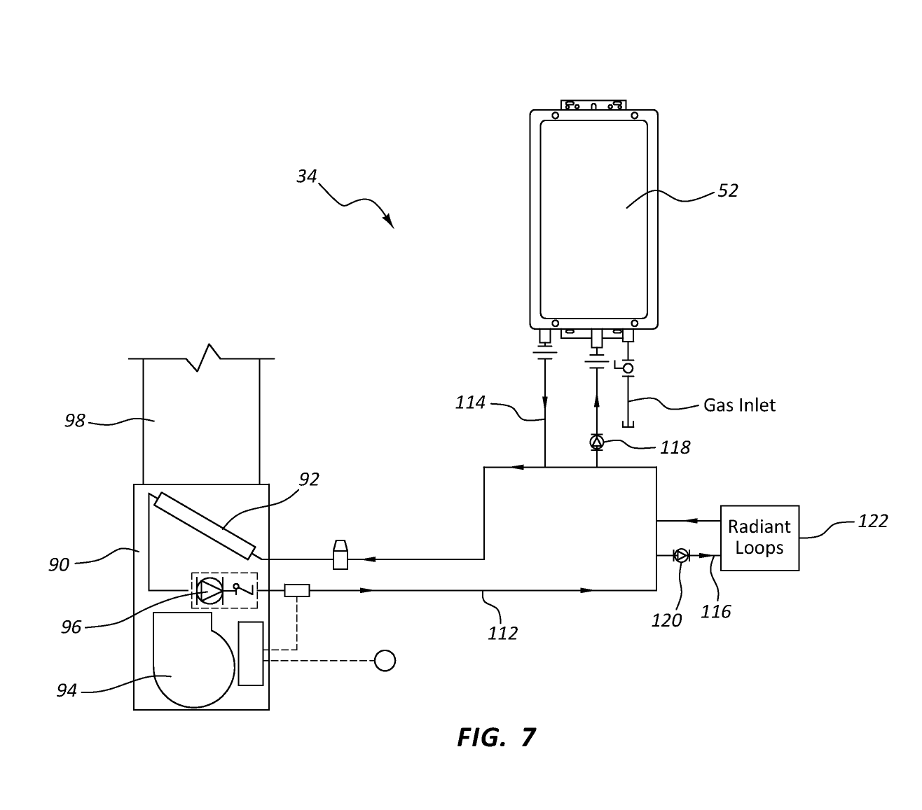

FIGS. 7-10 show schematic diagrams of various configuration of the piping for the hydronic heating system 34. FIG. 7 shows one embodiment that includes a primary circulating loop 112 (or primary circulation loop), a secondary circulating loop 114 (or secondary circulation loop), and a secondary circulating loop 116 (or secondary circulation loop). The primary/secondary loop configuration is a way to hydraulically separate different components of the system so that all components do not need to be capable of handling the full flow rate of the other components. For example, if the radiant loops 122 are only capable of handling a total flow of 3 gpm and the hydronic furnace 90 is capable of handling 5 gpm, then this configuration separates the two so that the radiant loops do not act to allow full flow through the hydronic furnace 90.

The pump 96 in the hydronic furnace 90 is used to circulate the liquid through the primary circulation loop 112. The secondary circulating loops 114, 116 each include a pump 118, 120 that draws liquid from the primary circulating loop 112 and passes it through the respective secondary circulating loop 114, 116.

It is preferable to position the heater 52 in a secondary circulating loop so that liquid flow through the heater 52 can be stopped when heat is not required. Stopping the flow of liquid through the heater 52 when it is not needed reduces unnecessary wear and tear on the heater 52.

FIG. 8 shows another embodiment of the piping for the hydronic heating system 34. This embodiment is similar to that shown in FIG. 7 except that the radiant loops 122 are now part of the primary circulating loop 112. This means that all of the liquid that flows through the primary circulating loop 112 must pass through both the hydronic furnace 90 and the radiant loops 122. It should be appreciated that the radiant loops 122 refer to the loops that extend through the floor 36, walls 38, 40, 42, 44, and/or the ceiling 46 as well as the loops that feed the manifolds for the portable radiant heating panels 82.

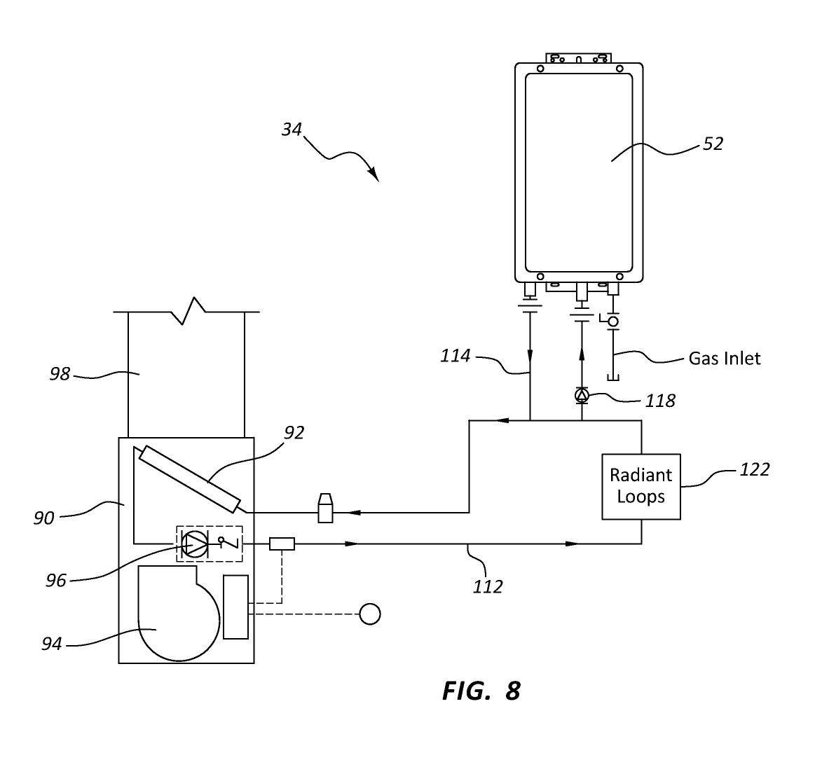

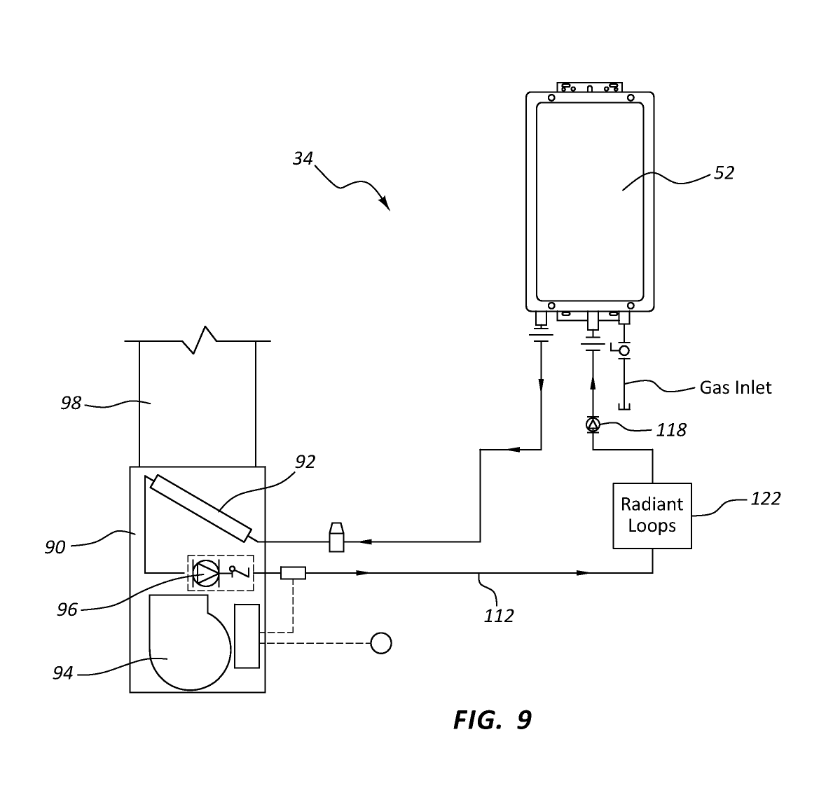

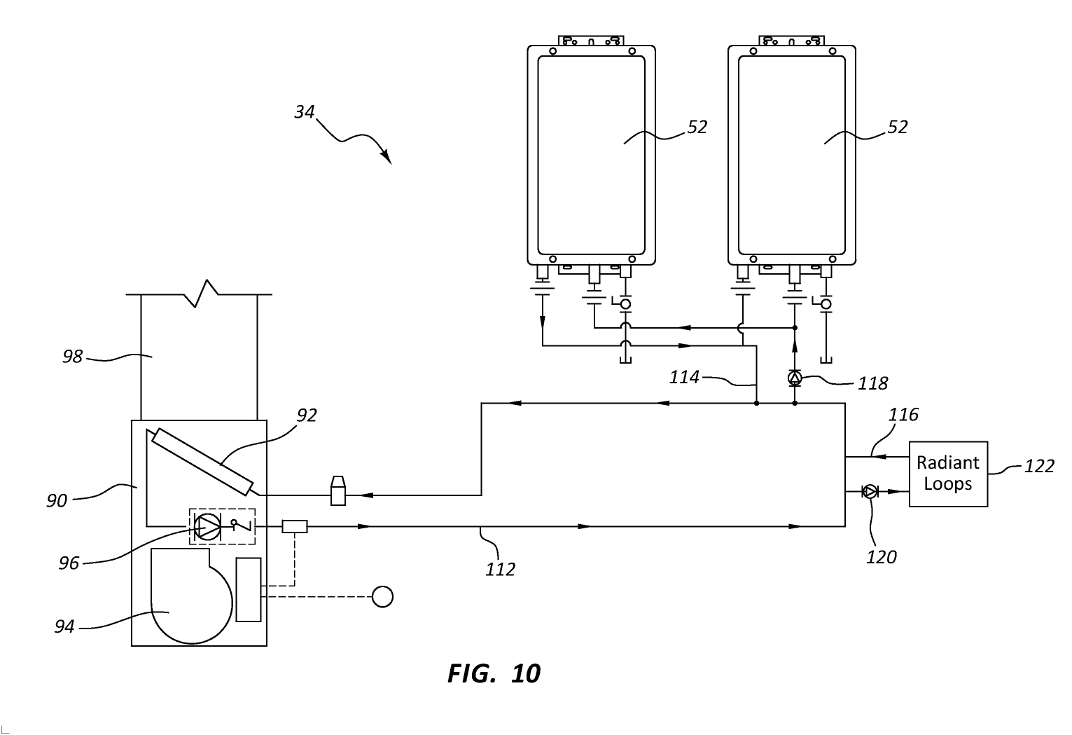

FIG. 9 shows another embodiment of the piping for the hydronic heating system 34 where the hydronic furnace 90, the radiant loops 122, and the heater 52 are all on a single primary circulating loop 112. FIG. 10 shows another embodiment of the piping for the hydronic heating system 34 that is similar to that shown in FIG. 7 except that two heaters 52 are positioned in the secondary circulating loop 114.

It should be appreciated that the piping also includes standard components associated with hydronic heating systems even though those aren't explicitly shown in the Figs. For example, the piping includes an expansion tank, pressure release valves, assorted valves that allow each section to be isolated, valves that allow the piping to be filled with liquid, etc.

The hydronic heating system 34 can include any suitable liquid. In one embodiment, the liquid includes water. It can also include antifreeze materials such as methanol, ethanol, ethylene glycol, and/or propylene glycol. Antifreeze materials do not hold as much heat as water and cause an increase in the pressure drop in the system, especially across components like heat exchangers (e.g., the heat exchanger in the hydronic furnace 90 and the heater 52). In one embodiment, the liquid includes an organic compound having no more than three carbon atoms and no more than two hydroxyl groups.

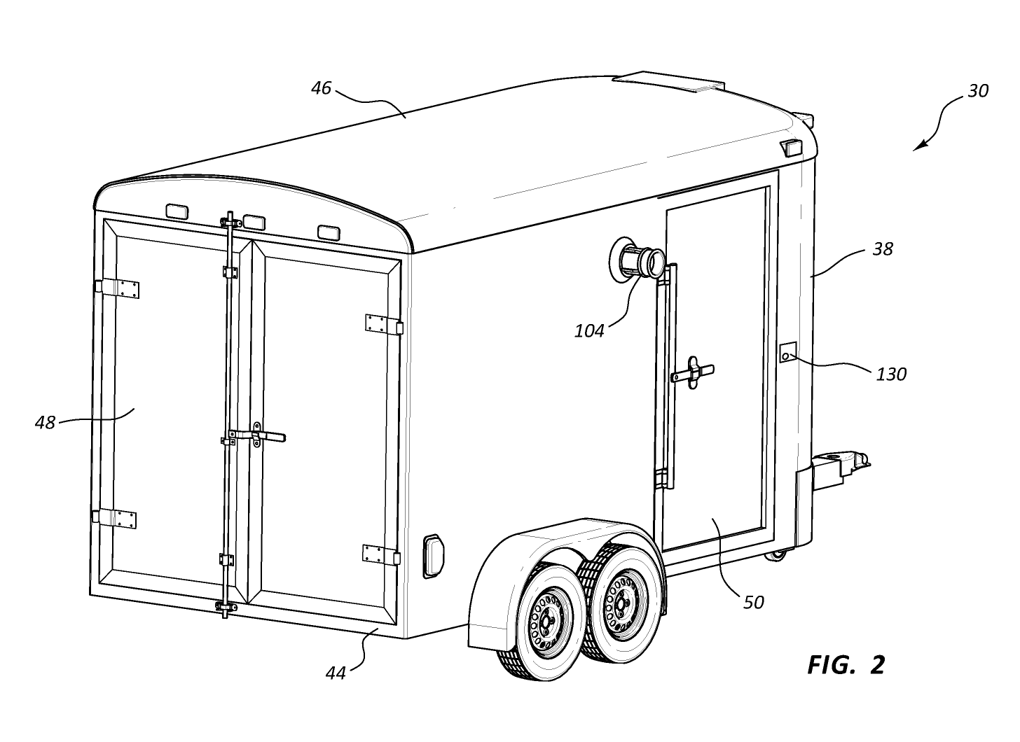

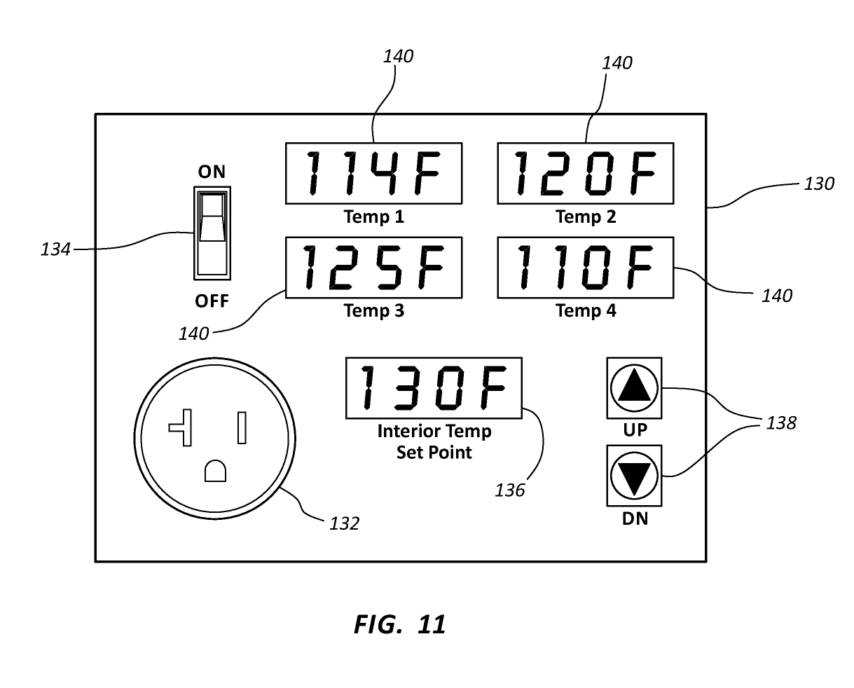

FIG. 11 shows one embodiment of a control panel 130 for the hydronic heating system 34. The control panel 130 can be positioned so that is accessible from the exterior of the cargo trailer 30 as shown in FIGS. 1-2. This allows the user to operate the hydronic heating system 34 without having access to the heater 52, the hydronic furnace 90, or associated components.

The control panel 130 includes an electrical outlet receptacle 132 through which power is supplied to the hydronic heating system 34. The electrical outlet receptacle 132 is shown as a female fitting but it can be a male or other type of fitting. One of the benefits of using a gas powered heater 52 is that the hydronic heating system 34 only needs a small amount of electricity to operate. The electrical components in the system 34 include a few pumps, the controls for the heater 52, and the blower for the hydronic furnace 90. All of these components can be powered using a standard 120V residential power connection. It should be appreciated that the cargo trailer 30 can also include a small generator that is capable of providing power for the hydronic heating system 34.

The control panel 130 also includes a master shutoff switch 134. This is used to shut off the system without disconnecting the electrical supply. When the master shutoff switch is moved to the off position, the pumps and blower are all shutoff. Power is still provided to the heater 52 so that it can maintain certain control functions. Without the pump 118 operating, however, the heater 52 cannot heat the liquid.

The control panel 130 also includes a temperature display 136 that displays the temperature set point for the interior of the enclosure 32. The buttons 138 can be used to adjust the temperature set point to whatever temperature is desired. When the temperature is not being adjusted the temperature display 136 displays the actual temperature inside the enclosure 32.

The control panel 130 also includes multiple temperature displays 140 that are connected to sensors inside the enclosure 32. The sensors can be placed in difficult to heat areas (e.g., between mattresses, in the middle of a pile of clothes, etc.) so that the user can monitor the heating process. Once the temperature displays 140 show that these areas have reached the kill temperature, then the user has a pretty good indication that everything has been treated and the bed bugs are all dead.

The hydronic heating system 34 can also include one or more emergency shutoff switches 142 in the interior of the enclosure 32. Anyone who gets caught in the enclosure 32 can push the shutoff switch 142 and stop the heating process. In one embodiment, the shutoff switch 142 is lighted so that it is easy to see and find in the dark—e.g., when the enclosure 32 is completely closed up.

The heated enclosure 32 can be used in any of a number of ways. In one embodiment, the heated enclosure 32 is used in combination with a traditional chemical pesticide treatment to kill bed bugs. For example, if a user has bed bugs and they are concentrated to a certain area such as a child's bed, then the user can request a traditional chemical treatment. However, the user may want to immediately stop the bed bugs from biting the child or the user. Chemical treatment doesn't begin to work immediately but if the user heats the child's bed and the user's own bed in the enclosure 32 then uses bed bug traps (FIG. 18) underneath the legs of the bed, the user will not have to worry about any more bites during the course of chemical treatment.

Chemical treatments can't be applied to items of clothing, bedding, and the like. The user can heat those items in the enclosure 32 to rid them of bed bugs without the hassle of running it all through the dryer or placing them in plastic bags in the sun for weeks and weeks.

It should be noted that for purposes of this disclosure, the term “coupled” means the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate member being attached to one another. Such joining may be permanent in nature or alternatively may be removable or releasable in nature.

### EXAMPLES

The following examples are provided to further illustrate the disclosed subject matter. They should not be used to constrict or limit the scope of the claims in any way.

### Example 1

In this example, an insulated cargo trailer was used to determine which of the following heating systems heat an item of furniture the fastest: (1) a hydronic radiant heating system, (2) a hydronic forced air heating system, or (3) both systems working together. The item of furniture was a hide-a-bed couch with the bed folded up inside the couch. The couch cushions were removed to expose the top surface of the bed mattress.

The cargo trailer was approximately 7 feet wide and approximately 14 feet long (exterior dimensions of the cargo box) and included a heated enclosure and a separate space for the heating equipment. The cargo trailer was configured similarly to the trailer shown in FIGS. 1-6.

The trailer was insulated to prevent heat from escaping through the floor, walls, and ceiling. The floor was insulated with approximately 3.5 inches of solid foam board (Foamular brand). The walls and ceiling were insulated with at least approximately 3.5 inches of spray foam insulation.

The hydronic heating system included a tankless water heater, a hydronic furnace, and four radiant tubing loops. The tankless water heater burned propane from tanks located at the front exterior of the trailer. The tankless water heater was a Rinnai model RL94i and it was capable of modulating the amount of heat produced from 10,300 BTUs/hr to 199,000 BTUs/hr.

The tankless water heater was configured to heat water that circulated through the heating system. The hydronic furnace included a heat exchanger that transferred heat from the water to the air. The heated air was blown into the enclosure by the furnace to heat the hide-a-bed couch. The air entered the enclosure through two vents near the top and returned to the furnace through a vent near the floor. The hydronic furnace was a Rinnai model AHB4S.

The radiant tubing loops include one loop for the floor, one loop for each of the side walls and a loop for the front wall for a total of four loops. The loops for the floor and side walls were approximately the same length and the loop for the front wall was significantly shorter. The radiant tubing was 0.5 inch Pex-Al-Pex (Pex-aluminum-Pex; Pex is crosslinked polyethylene) and was spaced six inches apart from each other (6 inch on center spacing). The radiant tubing layout for the floor, side walls, and front wall is shown in FIGS. 22-25.

The radiant tubing was positioned in aluminum heat transfer plates in the floor, side walls, and front wall to increase the heat transfer. The tubing and heating transfer plates were covered with aluminum sheeting or plate that formed the exterior surfaces of the floor, side walls, and front wall. The aluminum on the floor (0.100 inches thick) was diamond plated and thicker than the aluminum on the walls (0.040 inches thick). The ceiling and doors were not heated with radiant tubing.

The piping for the hydronic heating system was configured as follows. The system included a primary circulation loop that supplied water to the hydronic furnace, a secondary circulation loop that draws water from the primary circulation loop and sends it through the heater, and another secondary circulation loop that draws water from the primary circulation loop and sends it to a manifold and on to the four radiant tubing loops.

The water in the primary circulation loop is circulated by a pump included with the hydronic furnace. The secondary circulation loops each had a dedicated pump that pumps water from the primary circulation loop, through the respective secondary circulation loop, and back to the primary circulation loop.

The pump in the primary circulation loop—i.e., the pump included with the hydronic furnace—was always on when the enclosure was being heated. The hydronic furnace was turned off and on by switching the blower off and on. The pump in the secondary circulation loop for the radiant tubing was only on when the radiant heating system was running. The pump in the secondary circulation loop for the water heater was only on when the water in the primary circulation loop needed heat, i.e., the water temperature in the primary loop dropped below a set point.

The flow rate in the primary circulation loop was approximately 4.5 to 5.5 gallons per minute. The flow rate in the secondary circulation loop for the radiant tubing was approximately 3.5 to 4.5 gallons per minute. The flow rate in the secondary circulation loop for the heater was approximately 4 to 5 gallons per minute.

The hide-a-bed couch was heated three separate times to determine which heating method (i.e., radiant tubing alone, hydronic furnace alone, or combination of both) would heat the couch-bed faster. For each test, the tankless water heater was set to heat the water to 140° F. The tankless water heater was configured to run any time water was being pumped through it.

The tankless water heater was configured to modulate the burner output depending on the flow rate and temperature of the incoming water. The boiler shut completely off if the flow rate and incoming water temperature were such that, even at the lowest burner output, the tankless water heater caused the temperature of the water to overshoot the set point by more than ten degrees.

The pump that supplied water to the tankless water heater was shut off when the return water temperature in the primary circulation loop reached approximately 130° F. This temperature combined with the flow rate of the secondary circulation loop for the water heater was just below the maximum incoming temperature and flow rate at which the tankless water heater would modulate the burner off.

The temperature of the couch-bed was measured using a sensor positioned between the folded mattress. This sandwiched the sensor between opposite sides of the folded mattress so that the full thickness of the mattress was above and below the sensor. The sensor was in the most insulated location of the couch-bed during the tests.

Table 1 shows the data obtained from the tests.

TABLE 1
Heating Tests

| | | | | Radiant and | |
|---|---|---|---|---|---|
| | | | | Forced Air | |
| Radiant Only | | Forced Air Only | | | Couch- |
| Minutes | Couch-Bed (F.) | Minutes | Couch-Bed (F.) | Minutes | Bed (F.) |
| 0 | 80.6 | 0 | 75.1 | 0 | 68.9 |
| 3 | 80.6 | 10 | 75.2 | 17 | 70.5 |
| 20 | 81.7 | 14 | 75.6 | 20 | 71.4 |
| 30 | 83.5 | 20 | 76.6 | 30 | 74.8 |
| 40 | 85.5 | 30 | 79.0 | 40 | 78.1 |
| 50 | 87.8 | 45 | 82.9 | 50 | 81.1 |
| 60 | 90.3 | 61 | 87.2 | 55 | 82.6 |
| | | | | 61 | 84.4 |
| Tot. rise | 9.7 | Tot. rise | 12.1 | Tot. rise | 15.5 |

The test showed that only using radiant heats the couch-bed the slowest. Using only forced air heats the couch-bed approximately 25% faster than only using radiant. The best results were obtained by the combination of radiant and forced air. The couch-bed heated approximately 28% faster than using only forced air and approximately 60% faster than using only radiant. The results clearly show that the combination of radiant and forced air is the best way to quickly heat an item of furniture.

### Example 2

This example was performed using the same trailer and configuration described in Example 1 with the following changes. The liquid used in the heating system was a mixture of two parts water to one part methanol (by volume). In weight terms, the mixture was approximately 20-30 wt % methanol with the rest water. Also, the water heater was set to heat the liquid to 185° F. and the pump for the water heater was set to shut off when the return water temperature in the primary circulation loop reached 145° F. and turn back on when the return water temperature dropped to 135° F.

The couch-bed was configured in the manner described above. A combination of mattresses and box springs were also placed in the enclosure to be heated. They included, in this order, a twin size mattress, a full size box spring, a queen size box spring, and two queen size mattresses. The mattresses and box springs were stacked side by side without any space between them. A temperature sensor was placed in the center of the mattresses where it was most insulated—i.e., between the queen size box spring and the queen size mattress.

The following parameters were measured during this test. The temperature of the couch-bed, temperature of the mattresses, return water temperature, and the flow rate through the tankless water heater.

Table 2 shows the data obtained from the test.

TABLE 2
Heating Test

| Time | Couch-Bed | | Return Water | Heater Flow Rate |
|---|---|---|---|---|
| (min) | (F.) | Mattresses (F.) | Temp (F.) | (GPM) |
| 0 | 31.8 | 29 | 32 | 2.1 |
| 5 | 31.8 | 29 | 108 | 3.4 |
| 10 | 32.2 | 29 | 133 | 4.2 |
| 15 | 33.6 | 30 | 139 | 4.2 |
| 20 | 36.5 | 32 | 144 | 4.1 |
| 25 | 40.3 | 34 | 142 | 4.3 |
| 30 | 45.1 | 37 | 143 | 4.3 |
| 35 | 50.4 | 42 | 144 | 4.3 |
| 40 | 55.6 | 46 | 144 | 4.3 |
| 45 | 61.2 | 50 | 145 | — |
| 50 | 66.4 | 54 | 140 | — |
| 55 | 71.2 | 58 | 137 | — |
| 60 | 75.9 | 62 | 136 | — |
| 65 | 80.1 | 65 | 136 | — |
| 70 | 83.5 | 69 | 139 | — |
| 75 | 86.9 | 72 | 136 | — |
| 80 | 90.5 | 75 | 135 | 4.4 |
| 85 | 93.6 | 78 | 135 | — |
| 90 | 96.1 | 80 | 135 | 4.3 |
| 95 | 98.6 | 83 | 135 | 4.4 |
| 100 | 100.6 | 85 | 135 | — |
| 105 | 102.9 | 87 | 136 | — |
| 110 | 104.7 | 89 | 135 | — |
| 115 | 106.3 | 90 | 135 | — |
| 120 | 108.0 | 92 | 137 | — |
| 130 | 110.7 | 95 | 137 | — |
| 140 | 113.0 | 97 | 137 | — |
| 150 | 115.0 | 98 | 140 | — |
| 160 | 117.1 | 100 | 135 | 4.4 |
| 170 | 119.1 | 102 | 139 | — |
| 180 | 120.7 | 103 | 142 | — |
| 190 | 122.2 | 104 | 138 | — |
| 200 | 123.4 | 105 | 145 | — |
| 210 | 124.7 | 106 | No reading | — |
| 220 | 125.8 | 107 | 145 | — |
| 230 | 126.9 | 108 | 137 | — |
| 240 | 127.8 | 109 | 135 | — |
| 273 | 130.6 | 111 | 144 | — |
| 300 | 132.8 | 113 | 136 | — |

The results show that the enclosure is capable of heating the most difficult items to a temperature sufficient to kill bed bugs. These tests represent worst case scenarios since it is unlikely anyone would put five mattresses and box springs right next to each other in a real application.

It should be noted that the return water temperature reached approximately 145° F. after about 20 minutes. At this point, the tankless water heater began to cycle on and off (no water flow through the heater means it was off) until by the end of the test it was rarely on. This shows that once the heating system got up to temperature, the tankless water heater only had to turn on occasionally to maintain it. Most of the time, the system circulated hot liquid while waiting for the heat to transfer through the items in the enclosure.

The test results also indicate that the use of one or more portable heating panels can help speed up the heating process. For example, if a portable heating panel is placed between each mattress and/or box spring, then it would quickly heat them up to the desired temperature. Also, if a portable heating panel is placed between the folds in the couch-bed, then it too would heat up much faster.

The terms recited in the claims should be given their ordinary and customary meaning as determined by reference to relevant entries in widely used general dictionaries and/or relevant technical dictionaries, commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used in a manner that is more expansive than its ordinary and customary meaning, the term should be given its ordinary and customary meaning plus the additional expansive meaning, or (b) if a term has been explicitly defined to have a different meaning by reciting the term followed by the phrase “as used herein shall mean” or similar language (e.g., “herein this term means,” “as defined herein,” “for the purposes of this disclosure the term shall mean,” etc.).

References to specific examples, use of “i.e.,” use of the word “invention,” etc., are not meant to invoke exception (b) or otherwise restrict the scope of the recited claim terms. Other than situations where exception (b) applies, nothing contained herein should be considered a disclaimer or disavowal of claim scope.

The subject matter recited in the claims is not coextensive with and should not be interpreted to be coextensive with any particular embodiment, feature, or combination of features shown herein. This is true even if only a single embodiment of the particular feature or combination of features is illustrated and described herein. Thus, the appended claims should be given their broadest interpretation in view of the prior art and the meaning of the claim terms.

As used herein, spatial or directional terms, such as “left,” “right,” “front,” “back,” and the like, relate to the subject matter as it is shown in the drawings. However, it is to be understood that the described subject matter may assume various alternative orientations and, accordingly, such terms are not to be considered as limiting.

Articles such as “the,” “a,” and “an” can connote the singular or plural. Also, the word “or” when used without a preceding “either” (or other similar language indicating that “or” is unequivocally meant to be exclusive—e.g., only one of x or y, etc.) shall be interpreted to be inclusive (e.g., “x or y” means one or both x or y).

The term “and/or” shall also be interpreted to be inclusive (e.g., “x and/or y” means one or both x or y). In situations where “and/or” or “or” are used as a conjunction for a group of three or more items, the group should be interpreted to include one item alone, all of the items together, or any combination or number of the items. Moreover, terms used in the specification and claims such as have, having, include, and including should be construed to be synonymous with the terms comprise and comprising.

Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques.

All ranges disclosed herein are to be understood to encompass and provide support for claims that recite any and all subranges or any and all individual values subsumed therein. For example, a stated range of 1 to 10 should be considered to include and provide support for claims that recite any and all subranges or individual values that are between and/or inclusive of the minimum value of 1 and the maximum value of 10; that is, all subranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

1. An enclosure comprising:
a floor;
a ceiling located above the floor;
walls extending from the floor to the ceiling;
a door providing access to an interior of the enclosure; and
a hydronic heating system capable of heating the interior of the enclosure to at least approximately 110° F., the hydronic heating system comprising a hydronic forced air heating system and a hydronic radiant heating system including radiant tubing in the floor of the enclosure;
wherein the hydronic heating system does not use the radiant tubing in the floor to heat air in the hydronic forced air heating system.

2. The enclosure of claim 1 wherein the hydronic heating system is capable of heating the interior of the enclosure to at least approximately 130° F.

3. A vehicle comprising the enclosure in claim 1.

4-6. (canceled)

7. The enclosure of claim 1 wherein the hydronic heating system includes a liquid used to transfer heat to the interior of the enclosure.

8. The enclosure of claim 7 wherein liquid includes an organic compound having no more than three carbon atoms and no more than two hydroxyl groups.

9. The enclosure of claim 7 wherein the hydronic heating system uses combustion to heat the liquid.

10. The enclosure of claim 1 wherein the hydronic heating system includes a tankless water heater.

11. The enclosure of claim 1 comprising a portable heating panel positioned in the interior of the enclosure, the portable heating panel being selectively repositionable to various locations in the interior of the enclosure while being coupled to the hydronic heating system.

12. The enclosure of claim 1 wherein the floor, ceiling, and/or walls comprise one or more radiant heating panels that are heated by the hydronic heating system.

13. The enclosure of claim 1 comprising:
a heated compartment including the floor, the ceiling, the walls, and the door; and
an equipment compartment that is separate from the heated compartment;
wherein the hydronic heating system is capable of heating the interior of the heated compartment to at least approximately 110° F.; and
wherein the hydronic heating system includes a heater positioned in the equipment compartment and the hydronic forced air heating system includes a blower positioned in the equipment compartment.

14. An enclosure comprising:
a heated compartment comprising:
a floor;
a ceiling located above the floor;
walls extending from the floor to the ceiling; and
a door providing access to an interior of the heated compartment;
an equipment compartment that is separate from the heated compartment; and
a hydronic heating system positioned in the equipment compartment, the hydronic heating system being capable of heating the interior of the heated compartment to at least approximately 110° F.

15. The enclosure of claim 14 wherein the hydronic heating system comprises a hydronic forced air heating system including a heat exchanger and a blower both of which are positioned in the equipment compartment.

16. The enclosure of claim 15 wherein the hydronic heating system comprises a heater positioned in the equipment compartment and a hydronic radiant heating system including a circulation pump positioned in the equipment compartment.

17. An enclosure comprising:
a floor;
a ceiling located above the floor;
walls extending from the floor to the ceiling;
a door providing access to an interior of the enclosure;
a heating system capable of heating the interior of the enclosure to at least approximately 110° F.;
a portable heating panel positioned in the interior of the enclosure, the portable heating panel being selectively repositionable to various locations in the interior of the enclosure while being coupled to the heating system.

18. A method for killing bed bugs in an infested item, the method comprising:
positioning the infested item in an interior of an enclosure, the infested item including one or more bed bugs; and
heating the interior of the enclosure to a temperature and for a duration that is sufficient to kill the one or more bed bugs;
wherein the interior of the enclosure is heated using a hydronic heating system.

19. The method of claim 18 wherein the infested item includes a component of a bed, the method comprising isolating the bed from re-infestation by bed bugs after the bed has been heated to kill the bed bugs.

20. The method of claim 18 wherein the infested item is from an infested area in structure, the method comprising applying pesticide to the infested area in the structure.

21. The enclosure of claim 17 wherein the heating system is a hydronic heating system and the portable heating panel includes tubing tilled with a liquid, and wherein the tubing is configured to be coupled to and decoupled from the hydronic heating system.

22. The enclosure of claim 11, wherein the portable heating panel includes tubing filled with a liquid, and wherein the tubing is configured to be coupled to and decoupled from the hydronic heating system.
